(19) United States
(12) Patent Application Publication
(10) Pub. No.: US 2026/0261879 A1
(43) Pub. Date: Sep. 3, 2026

(54) TEST SYSTEM OF MULTI-SIM DEVICE AND TEST METHOD THEREOF

(71) Applicant: ANRITSU CORPORATION, Kanagawa (JP)

(72) Inventors: Junya TANAKA, Kanagawa (JP); Sayaka SHIMURA, Kanagawa (JP)

(21) Appl. No.: 19/421,170

(22) Filed: Dec. 16, 2025

(30) Foreign Application Priority Data
Mar. 3, 2025 (JP) 2025-032796

(51) Int. Cl. H04W 24/06; H04W 88/06

(52) U.S. Cl. CPC H04W 24/06; H04W 88/06

(57) ABSTRACT

A test system includes a plurality of simulated base station devices that simulate a base station of a radio communication system in correspondence with each of a plurality of SIMs of a multi-SIM device, and a mobile terminal test device that tests the multi-SIM device by controlling the plurality of simulated base station devices, in which the mobile terminal test device includes a plurality of base station control portions that control the simulated base station devices in correspondence with each of the plurality of simulated base station devices, one primary scenario processing portion that controls communication corresponding to one SIM of the multi-SIM device by controlling one of the plurality of base station control portions, and one or more secondary scenario processing portions that control communication corresponding to one SIM of the multi-SIM device by controlling one of the plurality of base station control portions.

### TECHNICAL FIELD

The present invention relates to a test system that simulates a base station of a radio communication system to test a multi-SIM device that is a device on which a plurality of subscriber identity modules (SIMs) can be installed.

### BACKGROUND ART

In recent years, devices such as mobile terminals on which two SIMs are installed to enable communication using each SIM have emerged.

In the disclosure of Patent Document 1, a dual SIM dual standby terminal includes two receivers and one transmitter and is equipped with two SIMs such that two SIMs can be put on standby at the same time and simultaneous calling on the two SIMs cannot be performed. When an incoming call is received on one SIM during a call on the other SIM, simultaneous calling is implemented by switching between calls on the two SIMs by responding to a sender of the other SIM using time-division duplex for an uplink, which is transmission from the terminal to a base station, and switching uplink transmission between the two SIMs.

### Related art Document

### Patent Document

Patent Document 1 JP-A-2023-36594

### Disclosure of the Invention

### Problem that the Invention is to Solve

Testing such devices requires a test device that can receive an incoming call on one SIM during a call on the other SIM or perform simultaneous calling on two SIMs.

However, current test devices are designed for devices having one SIM and do not support tests of devices supporting a plurality of SIMs.

Developing a new test device that can test devices supporting a plurality of SIMs requires a cost and time.

Therefore, an object of the present invention is to provide a test system of a multi-SIM device that can inexpensively and quickly build a test configuration for a device on which a plurality of SIMs can be installed.

### Means for solving the problem

According to the present invention, there is provided a test system of a multi-SIM device on which a plurality of SIMs are installed and that is capable of executing communication corresponding to each SIM at the same time, the test system including a plurality of simulated base station devices (2a, 2b) that simulate a base station of a radio communication system in correspondence with each of the plurality of SIMs of the multi-SIM device, and a mobile terminal test device (1) that tests the multi-SIM device by controlling the plurality of simulated base station devices, in which the mobile terminal test device includes a plurality of base station control portions (11a, 11b) that control the simulated base station devices in correspondence with each of the plurality of simulated base station devices, one primary scenario processing portion (12) that controls communication corresponding to one SIM of the multi-SIM device by controlling one of the plurality of base station control portions, and one or more secondary scenario processing portions (13) that control communication corresponding to one SIM of the multi-SIM device by controlling one of the plurality of base station control portions.

In this configuration, the primary scenario processing portion instructs the secondary scenario processing portion to start a process and ends a process after confirming an end of the process of the secondary scenario processing portion. Thus, a device on which a plurality of SIMs can be installed can be tested, and a test configuration for a device on which a plurality of SIMs can be installed can be inexpensively and quickly built.

In the test system of a multi-SIM device according to the present invention, the primary scenario processing portion may confirm an end of a process of the secondary scenario processing portion by periodically referring to a state of the process of the secondary scenario processing portion.

In this configuration, the primary scenario processing portion confirms the end of the process of the secondary scenario processing portion by periodically referring to the state of the process of the secondary scenario processing portion. Thus, the process of confirming the end of the process of the secondary scenario processing portion can be easily understood.

In the test system of a multi-SIM device according to the present invention, in a case where the process of the secondary scenario processing portion ends with error, the primary scenario processing portion may end the process with error, and in a case where the process of the primary scenario processing portion ends with error, the primary scenario processing portion may instruct the secondary scenario processing portion to end the process and end with error after confirming the end of the process of the secondary scenario processing portion.

In this configuration, in a case where the process of the secondary scenario processing portion ends with error, the process of the primary scenario processing portion ends with error, and in a case where the process of the primary scenario processing portion ends with error, the primary scenario processing portion instructs the secondary scenario processing portion to end the process and ends with error after confirming the end of the process of the secondary scenario processing portion. Thus, the processes can be quickly ended without missing an occurrence of error.

According to the present invention, there is provided a test method using a test system of a multi-SIM device, the test system including a plurality of simulated base station devices (2a, 2b) that simulate a base station of a radio communication system in correspondence with each of a plurality of SIMs of the multi-SIM device, and a plurality of base station control portions (11a, 11b) that control the simulated base station devices in correspondence with each of the plurality of simulated base station devices, the test method including a step of controlling communication corresponding to one SIM of the multi-SIM device by controlling one of the plurality of base station control portions through one primary scenario process, and a step of controlling communication corresponding to one SIM of the multi-SIM device by controlling one of the plurality of base station control portions through one or more secondary scenario processes, in which the primary scenario process includes a step of instructing the secondary scenario process to start a process, and a step of ending a process after confirming an end of the process of the secondary scenario process.

In this configuration, the primary scenario process instructs the secondary scenario process to start a process and ends the process after confirming the end of the process of the secondary scenario process. Thus, a device on which a plurality of SIMs can be installed can be tested, and a test configuration for a device on which a plurality of SIMs can be installed can be inexpensively and quickly built.

### Advantage of the Invention

The present invention can provide a test system of a multi-SIM device that can inexpensively and quickly build a test configuration for a device on which a plurality of SIMs can be installed.

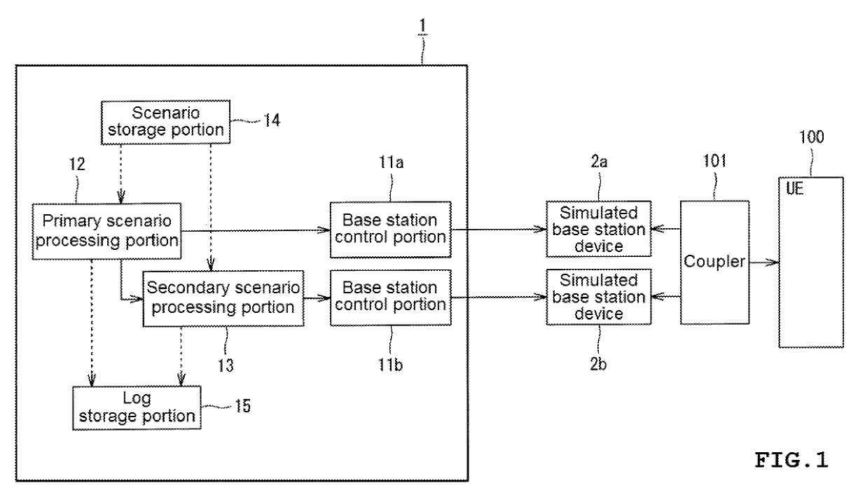

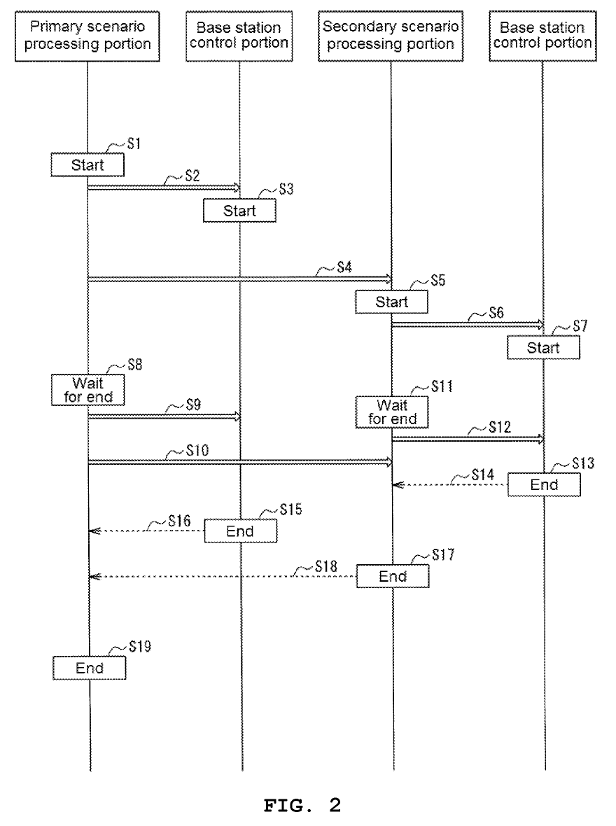

### BRIEF DESCRIPTION OF THE DRAWINGS

[FIG. 1] FIG. 1 is a block diagram of a test system of a multi-SIM device according to an embodiment of the present invention.

[FIG. 2] FIG. 2 is a sequence diagram for describing a procedure of conducting a test using communication of two SIMs of the test system of the multi-SIM device according to the embodiment of the present invention at the same time.

### BEST MODE FOR CARRYING OUT THE INVENTION

Hereinafter, a test system of a multi-SIM device according to an embodiment of the present invention will be described in detail with reference to the drawings.

In FIG. 1, the test system of the multi-SIM device according to the embodiment of the present invention is configured to include a mobile terminal test device 1 and a plurality of simulated base station devices 2a and 2b.

In the test system of the present embodiment, the mobile terminal test device 1 tests a multi-SIM device 100 as user equipment (UE) by controlling the plurality of simulated base station devices 2a and 2b. The mobile terminal test device 1 and the plurality of simulated base station devices 2a and 2b are connected through, for example, a local area network (LAN) and can transmit and receive various types of information to and from each other.

The simulated base station devices 2a and 2b transmit and receive a radio frequency (RF) signal to and from the multi-SIM device 100 in a wired manner via a coaxial cable, a coupler 101, and the like.

The coupler 101 collectively connects the plurality of simulated base station devices 2a and 2b to an antenna terminal of the multi-SIM device 100 and combines RF signals from the plurality of simulated base station devices 2a and 2b to transmit the combined RF signal to the multi-SIM device 100 or distributes the RF signals from the multi-SIM device 100 to the plurality of simulated base station devices 2a and 2b.

The mobile terminal test device 1 is configured with a computer unit including a central processing unit (CPU), a random access memory (RAM), a read only memory (ROM), a flash memory, a hard disk device, an input port, and an output port.

In the computer unit, the CPU can control devices connected to the input port and the output port by executing an operating system (OS) stored in the hard disk device.

The mobile terminal test device 1 is configured with, for example, a personal computer device to which a keyboard, a mouse, and a display device are connected.

The mobile terminal test device 1 is configured to include a plurality of base station control portions 11a and 11b, a primary scenario processing portion 12, a secondary scenario processing portion 13, a scenario storage portion 14, and a log storage portion 15.

The base station control portions 11a and 11b are connected to the corresponding simulated base station devices 2a and 2b, respectively, and control the corresponding simulated base station devices 2a and 2b to control communication with the multi-SIM device 100.

The base station control portions 11a and 11b transmit information on the signals transmitted to and received from the multi-SIM device 100 by the corresponding simulated base station devices 2a and 2b, a test result, and the like to the corresponding primary scenario processing portion 12 or the secondary scenario processing portion 13.

The primary scenario processing portion 12 controls the base station control portion 11a to cause the simulated base station device 2a to communicate with the multi-SIM device 100 based on a test scenario created by an operation of the user and stored in the scenario storage portion 14.

The primary scenario processing portion 12 stores the information on the signals transmitted to and received from the multi-SIM device 100 by the simulated base station device 2a, the test result, and the like received from the base station control portion 11a in the log storage portion 15 as a log file.

The secondary scenario processing portion 13 controls the base station control portion 11b to cause the simulated base station device 2b to communicate with the multi-SIM device 100 based on the test scenario created by the operation of the user and stored in the scenario storage portion 14.

The secondary scenario processing portion 13 stores the information on the signals transmitted to and received from the multi-SIM device 100 by the simulated base station device 2b, the test result, and the like received from the base station control portion 11b in the log storage portion 15 as a log file.

The scenario storage portion 14 is configured with a hard disk device or the like and stores the test scenario generated based on information input by the user for testing the multi-SIM device 100. In the test scenario, settings of operations of the simulated base station devices 2a and 2b, a communication sequence with respect to the multi-SIM device 100, and the like are set.

The log storage portion 15 is configured with a hard disk device or the like and stores the log files from the primary scenario processing portion 12 and the secondary scenario processing portion 13. The log files are individually stored in each of the primary scenario processing portion 12 and the secondary scenario processing portion 13.

The primary scenario processing portion 12, the secondary scenario processing portion 13, and the base station control portions 11a and 11b are configured with a program stored in the hard disk device of the mobile terminal test device 1. The primary scenario processing portion 12, the secondary scenario processing portion 13, and the base station control portions 11a and 11b operate on the OS of the mobile terminal test device 1 and control communication with the simulated base station devices 2a and 2b and the keyboard, the mouse, the display device, and the like via the OS to control the test of the multi-SIM device 100.

The primary scenario processing portion 12 and the secondary scenario processing portion 13 can transmit and receive information to and from each other via the OS. The primary scenario processing portion 12 can transmit and receive information to and from the base station control portion 11a via the OS. The secondary scenario processing portion 13 can transmit and receive information to and from the base station control portion 11b via the OS.

The simulated base station devices 2a and 2b transmit and receive RF signals to and from the multi-SIM device 100 under control of the base station control portions 11a and 11b. The simulated base station devices 2a and 2b control communication with the multi-SIM device 100 based on commands input from the base station control portions 11a and 11b. The simulated base station devices 2a and 2b transmit a state and the like of communication with the multi-SIM device 100 to the base station control portions 11a and 11b.

In the test system having such a configuration, in a case where the test is conducted by simultaneously using a plurality of communications corresponding to a plurality of SIMs of the multi-SIM device 100, the primary scenario processing portion 12, the base station control portion 11a, and the simulated base station device 2a are grouped to perform communication corresponding to one SIM, and the secondary scenario processing portion 13, the base station control portion 11b, and the simulated base station device 2b are prepared as one group in correspondence with the other SIMs. An increase in the number of SIMs can be handled by adding the group of the secondary scenario processing portion 13, the base station control portion 11b, and the simulated base station device 2b.

The test scenario is created for the communication of each of the plurality of SIMs. In the test scenario corresponding to the primary scenario processing portion 12, a scenario using the plurality of simulated base station devices 2a and 2b is designated, and any timing of the test scenario at which the test scenario in the secondary scenario processing portion 13 starts, a test scenario executed in the secondary scenario processing portion 13, and the like are also designated.

In a case where the primary scenario processing portion 12 is started by an operation of the user, the test proceeds using the procedure shown in FIG. 2.

In step S1, in a case where the test scenario using the plurality of SIMs of the multi-SIM device 100 is designated and an instruction to start the test is provided, the primary scenario processing portion 12 in step S2 instructs the base station control portion 11a to start the test.

In step S3, the base station control portion 11a that has received the instruction to start the test starts the test.

In step S4, in a case where the start of the test scenario in the secondary scenario processing portion 13 is designated, the primary scenario processing portion 12 sets necessary parameters such as the test scenario to be executed, a control software configuration, and a log storage setting and then instructs the secondary scenario processing portion 13 to start the test scenario.

The secondary scenario processing portion 13 that has received the instruction to start the test scenario starts the test scenario in step S5 and instructs the base station control portion 11b to start the test in step S6.

In step S7, the base station control portion 11b that has received the instruction to start the test starts the test.

In step S8, the primary scenario processing portion 12 enters an end wait state, and in a case where the test scenario of the secondary scenario processing portion 13 ends with error, the primary scenario processing portion 12 stops its execution and ends with error. In a case where the test scenario of the secondary scenario processing portion 13 ends normally, the primary scenario processing portion 12 waits for the end of the test of the base station control portion 11a and, in a case where the test of the base station control portion 11a ends normally, ends normally.

In a case where the test of the base station control portion 11a ends normally earlier than the test scenario of the secondary scenario processing portion 13, the primary scenario processing portion 12 waits for the end of the test scenario of the secondary scenario processing portion 13. In a case where the test scenario of the secondary scenario processing portion 13 ends with error, the primary scenario processing portion 12 ends with error. In a case where the test scenario of the secondary scenario processing portion 13 ends normally, the primary scenario processing portion 12 ends normally.

In a case where the test of the base station control portion 11a ends with error, the primary scenario processing portion 12 instructs the secondary scenario processing portion 13 to end execution of the test scenario, waits for the end of the secondary scenario processing portion 13, and ends with error.

In step S9, the primary scenario processing portion 12 periodically acquires a state of the base station control portion 11a and waits for the end of the base station control portion 11a.

In step S10, the primary scenario processing portion 12 periodically acquires a state of the secondary scenario processing portion 13 and waits for the end of the secondary scenario processing portion 13.

In step S11, the secondary scenario processing portion 13 enters the end wait state, and in step S12, the secondary scenario processing portion 13 periodically acquires a state of the base station control portion 11b and waits for the end of the base station control portion 11b.

In step S13, in a case where the process of the base station control portion 11b ends, the secondary scenario processing portion 13, in step S14, detects the end of the process by acquiring the state of the base station control portion 11b.

In step S15, in a case where the process of the base station control portion 11a ends, the primary scenario processing portion 12, in step S16, detects the end of the process by acquiring the state of the base station control portion 11a.

In step S17, in a case where the process of the secondary scenario processing portion 13 ends, the primary scenario processing portion 12, in step S18, detects the end of the process by acquiring the state of the secondary scenario processing portion 13.

In step S19, the primary scenario processing portion 12 confirms that all processes have ended, and ends the execution of the scenario.

In the above embodiment, the primary scenario processing portion 12 instructs the secondary scenario processing portion 13 to start the scenario and ends the scenario after confirming the end of the process of the secondary scenario processing portion 13.

Accordingly, the primary scenario processing portion 12 and the secondary scenario processing portion 13 can perform communications corresponding to different SIMs at the same time, and a device on which a plurality of SIMs can be installed can be tested.

The primary scenario processing portion 12 and the secondary scenario processing portion 13 are created from a scenario processing portion that tests one SIM, and the base station control portions 11a and 11b and the simulated base station devices 2a and 2b use the configuration for testing one SIM. Thus, a test configuration for a device on which a plurality of SIMs can be installed can be inexpensively and quickly built.

The primary scenario processing portion 12 confirms the end of the process of the secondary scenario processing portion 13 by periodically acquiring the state of the secondary scenario processing portion 13.

Accordingly, the primary scenario processing portion 12 can autonomously confirm the end of the process of the secondary scenario processing portion 13, and the process of confirming the end of the process of the secondary scenario processing portion 13 can be easily understood.

In a case where the process of the secondary scenario processing portion 13 ends with error, the primary scenario processing portion 12 ends with error. In a case where the process of the primary scenario processing portion 12 ends with error, the primary scenario processing portion 12 instructs the secondary scenario processing portion 13 to end the process and ends with error after confirming the end of the process of the secondary scenario processing portion 13.

Accordingly, in a case where the process of the secondary scenario processing portion 13 ends with error, the process of the primary scenario processing portion 12 ends with error. In a case where the process of the primary scenario processing portion 12 ends with error, the secondary scenario processing portion 13 is instructed to end the process, and the process of the primary scenario processing portion 12 ends with error after the end of the process of the secondary scenario processing portion 13 is confirmed. Thus, the processes can be quickly ended without missing an occurrence of error.

While the embodiment of the present invention has been disclosed, those skilled in the art may apparently understand that changes may be made without departing from the scope of the present invention. All such corrections and equivalents are intended to fall within the following claims.

### DESCRIPTION OF REFERENCE NUMERALS AND SIGNS

1 Mobile terminal test device

2a, 2b Simulated base station device

11a, 11b Base station control portion

12 Primary scenario processing portion

13 Secondary scenario processing portion

100 Multi-SIM device

What is claimed is:

1. A test system of a multi-SIM device on which a plurality of SIMs are installed and that is capable of executing communication corresponding to each SIM at the same time, the test system comprising:
a plurality of simulated base station devices that simulate a base station of a radio communication system in correspondence with each of the plurality of SIMs of the multi-SIM device; and
a mobile terminal test device that tests the multi-SIM device by controlling the plurality of simulated base station devices,
wherein the mobile terminal test device includes
a plurality of base station control portions that control the simulated base station devices in correspondence with each of the plurality of simulated base station devices,
one primary scenario processing portion that controls communication corresponding to one SIM of the multi-SIM device by controlling one of the plurality of base station control portions, and
one or more secondary scenario processing portions that control communication corresponding to one SIM of the multi-SIM device by controlling one of the plurality of base station control portions.

2. The test system of a multi-SIM device according to claim 1,
wherein the primary scenario processing portion instructs the secondary scenario processing portion to start a process and ends a process after confirming an end of the process of the secondary scenario processing portion.

3. The test system of a multi-SIM device according to claim 1,
wherein the primary scenario processing portion confirms an end of a process of the secondary scenario processing portion by periodically referring to a state of the process of the secondary scenario processing portion.

4. The test system of a multi-SIM device according to claim 2,
wherein in a case where the process of the secondary scenario processing portion ends with error, the primary scenario processing portion ends the process with error, and in a case where the process of the primary scenario processing portion ends with error, the primary scenario processing portion instructs the secondary scenario processing portion to end the process and ends with error after confirming the end of the process of the secondary scenario processing portion.

5. The test system of a multi-SIM device according to claim 3,
wherein in a case where the process of the secondary scenario processing portion ends with error, the primary scenario processing portion ends the process with error, and in a case where the process of the primary scenario processing portion ends with error, the primary scenario processing portion instructs the secondary scenario processing portion to end the process and ends with error after confirming the end of the process of the secondary scenario processing portion.

6. A test method using a test system of a multi-SIM device, the test system including
a plurality of simulated base station devices that simulate a base station of a radio communication system in correspondence with each of a plurality of SIMs of the multi-SIM device, and
a plurality of base station control portions that control the simulated base station devices in correspondence with each of the plurality of simulated base station devices,
the test method comprising:
a step of controlling communication corresponding to one SIM of the multi-SIM device by controlling one of the plurality of base station control portions through one primary scenario process; and
a step of controlling communication corresponding to one SIM of the multi-SIM device by controlling one of the plurality of base station control portions through one or more secondary scenario processes.

7. The test method using a test system of a multi-SIM device according to claim 6,
wherein the primary scenario process includes
a step of instructing the secondary scenario process to start a process, and
a step of ending a process after confirming an end of the process of the secondary scenario process.

8. The test method using a test system of a multi-SIM device according to claim 6,
wherein the primary scenario process includes a step of confirming an end of the secondary scenario process by periodically referring to a state of the secondary scenario process.

9. The test method using a test system of a multi-SIM device according to claim 7,
wherein the primary scenario process includes
a step of ending the primary scenario process with error in a case where the secondary scenario process ends with error, and
a step of instructing the secondary scenario process to end the process and ending with error after confirming an end of the secondary scenario process in a case where the primary scenario process ends with error.

10. The test method using a test system of a multi-SIM device according to claim 8,
wherein the primary scenario process includes
a step of ending the primary scenario process with error in a case where the secondary scenario process ends with error, and
a step of instructing the secondary scenario process to end the process and ending with error after confirming an end of the secondary scenario process in a case where the primary scenario process ends with error.
